(19) United States
(12) Patent Application Publication
(10) Pub. No.: US 2026/0287769 A1
(43) Pub. Date: Sep. 24, 2026

(54) ADAPTIVE MERGING MIGRATION

(71) Applicant: SAUDI ARABIAN OIL COMPANY, Dhahran (SA)

(72) Inventor: Lu Liu, Beijing (CN)

(73) Assignee: ARAMCO FAR EAST (BEIJING) BUSINESS SERVICES CO., LTD., Beijing (CN)

(21) Appl. No.: 19/473,084

(22) PCT Filed: Apr. 14, 2023
(86) PCT No.: PCT/CN2023/088330

§ 371 Date: Oct. 6, 2025

(51) Int. Cl. G01V 1/28; G01V 1/32; G01V 1/34

(52) U.S. Cl. CPC G01V 1/282; G01V 1/32; G01V 1/34; G01V 2210/51; G01V 2210/57

(57) ABSTRACT

Examples of methods and systems are disclosed. The methods may include obtaining seismic data regarding a subsurface region of interest. The seismic data includes a source wavefield and a receiver wavefield. The methods may further include forming a reference seismic image. The methods may still include determining a plurality of local plane-wave receiver wavefields, each local plane-wave receiver wavefield is parameterized by a ray-parameter. The methods may also include forming, for each ray-parameter, a local plane-wave seismic image. The methods may further include determining a spatially-varying weight based, at least in part, on a metric of similarity between the reference seismic image and the local plane-wave seismic image. The methods may still further include forming a spatially-weighted local plane-wave seismic image based, at least in part, on the spatially-varying weight. The methods may also include forming a merged seismic image based on the spatially-weighted local plane-wave seismic images.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic data set.

To determine the earth structure, including the presence of hydrocarbons, the seismic data set may be processed. Processing seismic data includes the generation of a seismic velocity model and seismic migration. Processing a seismic data set includes a sequence of steps designed to correct for a number of issues, such as near-surface effects, noise, irregularities in the seismic survey geometry, etc. Another step in processing a seismic data set may be the mitigation of inaccuracies related to the seismic velocity model. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method includes obtaining seismic data regarding a subsurface region of interest, where the seismic data includes a source wavefield and a receiver wavefield and a velocity model regarding the subsurface region of interest. The method further includes forming a reference seismic image based, at least in part, on the seismic data and the velocity model, by extrapolating the receiver wavefield and the source wavefield and using a first imaging condition. The method still further includes determining a plurality of local plane-wave receiver wavefields from the receiver wavefield, where each local plane-wave receiver wavefield is parameterized by a value of a ray-parameter, and forming, for each value of the ray-parameter, a local plane-wave seismic image based, at least in part, on the local plane-wave receiver wavefield corresponding to the ray-parameter and the source wavefield using a second imaging condition. The method also includes determining, for each value of the ray-parameter, a spatially-varying weight based, at least in part, on a metric of similarity between the reference seismic image and the local plane-wave seismic image and forming, for each value of the ray-parameter, a spatially-weighted local plane-wave seismic image based, at least in part, on the spatially-varying weight and the local plane-wave seismic image. The method also includes forming a merged seismic image based, at least in part, on the spatially-weighted local plane-wave seismic images; and determining a drilling target in the subsurface region based on the merged seismic image.

In general, in one aspect, embodiments disclosed herein relate to a non-transitory computer-readable medium comprising computer-executable instructions stored thereon that, when executed on a processor, cause the processor to perform the steps of obtaining seismic data, including a source wavefield and a receiver wavefield, and a velocity model regarding the subsurface region of interest. The steps include forming a reference seismic image based, at least in part, on the seismic data and the velocity model, by extrapolating the receiver wavefield and the source wavefield and using a first imaging condition and determining a plurality of local plane-wave receiver wavefields from the receiver wavefield, where each local plane-wave receiver wavefield is parameterized by a value of a ray-parameter. The steps further include, for each value of the ray-parameter, forming a local plane-wave seismic image based, at least in part, on the local plane-wave receiver wavefield corresponding to the ray-parameter and the source wavefield using a second imaging condition, determining a spatially-varying weight based, at least in part, on a metric of similarity between the reference seismic image and the local plane-wave seismic image, and forming a spatially-weighted local plane-wave seismic image based, at least in part, on the spatially-varying weight and the local plane-wave seismic image. Finally, the steps include forming a merged seismic image based, at least in part, on the spatially-weighted local plane-wave seismic images; and determining, a drilling target in the subsurface region based on the merged seismic image.

In general, in one aspect, embodiments disclosed herein relate to a system. The system includes a seismic acquisition system, configured to record seismic data regarding a subsurface region of interest, and a seismic processor. The seismic processor is configured to receive the seismic data regarding a subsurface region of interest, where the seismic data includes a source wavefield and a receiver wavefield. The seismic processor is also configured to obtain a velocity model regarding the subsurface region of interest and to form a reference seismic image based, at least in part, on the seismic data and the velocity model, by extrapolating the receiver wavefield and the source wavefield and using a first imaging condition. The seismic processor is further configured to determine a plurality of local plane-wave receiver wavefields from the receiver wavefield, where each local plane-wave receiver wavefield is parameterized by a value of a ray-parameter, and to form, for each value of the ray-parameter, a local plane-wave seismic image based, at least in part, on the local plane-wave receiver wavefield corresponding to the ray-parameter and the source wavefield using a second imaging condition. The seismic processor is further configured to determine, for each value of the ray-parameter, a spatially-varying weight based, at least in part, on a metric of similarity between the reference seismic image and the local plane-wave seismic image. The seismic processor is still further configured to form, for each value of the ray-parameter, a spatially-weighted local plane-wave seismic image based, at least in part, on the spatially-varying weight and the local plane-wave seismic image. The seismic processor is also configured to form a merged seismic image based, at least in part, on the spatially-weighted local plane-wave seismic images. The seismic processor is further configured to determine a drilling target in the subsurface region based on the merged seismic image.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 shows a seismic acquisition system of a subsurface region of interest, according to one or more embodiments of the present disclosure.

FIG. 2 shows examples of seismic data produced by a seismic acquisition system in accordance with one or more embodiments.

FIG. 3 shows a drilling system in accordance with one or more embodiments.

FIG. 4 shows a flowchart in accordance with one or more embodiments.

FIG. 5 illustrates a velocity model for a simplified subsurface structure in accordance with one or more embodiments.

FIG. 6 shows examples of local plane-wave components a seismic image generated with an accurate seismic velocity model in accordance with one or more embodiments.

FIG. 7 shows examples of local plane-wave components of a seismic image generated with an inaccurate seismic velocity model in accordance with one or more embodiments.

FIG. 8 shows a flowchart in accordance with one or more embodiments.

FIG. 9 shows examples of a merged and a reference seismic image in accordance with one or more embodiments.

FIG. 10 illustrates an accurate velocity model, a smoothed velocity model, and examples of a merged and a reference seismic image in accordance with one or more embodiments.

FIG. 11 illustrates a velocity model, and a merged and a reference seismic image generated from marine seismic data in accordance with one or more embodiments.

FIG. 12 illustrates a block diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

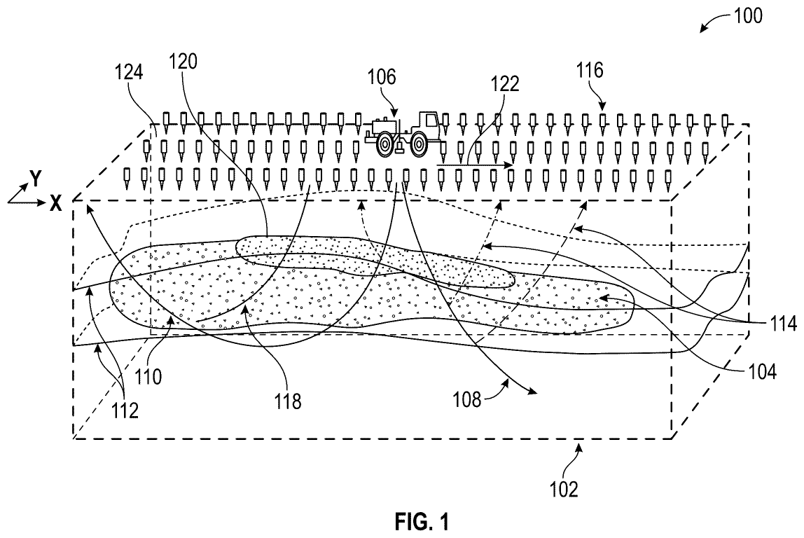

In the following description of FIGS. 1-12, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to generate seismic images by weighting and merging their plane-wave components. In some embodiments, the plane wave components may be local plane-wave components. In particular, some embodiments generate seismic images by migration techniques that make use of seismic velocity models of the subsurface region of interest. The quality of the generated seismic image is then significantly affected by the accuracy of the seismic velocity model. Even though the generation of an accurate seismic velocity model is desired, it may be difficult to achieve because of low-quality seismic data and simplifying modelling hypotheses. Some embodiments implement techniques to mitigate the effects of inaccuracies in a seismic velocity model based on evaluation of the quality of the seismic image. For example, extrapolated seismic wavefields may be decomposed into plane-wave components, particularly local plane-wave components, to generate corresponding plane-wave seismic images. Each plane-wave component may be affected differently by the erroneous velocities of the seismic velocity model. A weighting scheme may be implemented to identify high-quality regions in the plane-wave seismic image. Effects of an inaccurate seismic velocity model on the seismic image may be reduced by adaptive merging the identified high-quality regions to generate a merged seismic image.

The resulting merged seismic image may then be used for further seismic data interpretation, such as in updating the spatial extension of a hydrocarbon reservoir. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

FIG. 1 shows a seismic acquisition system (100) of a subsurface region of interest (102), according to one or more embodiments. In some cases, the subsurface region of interest (102) may lie beneath a lake, sea, or ocean. In other cases, the subsurface region of interest (102) may lie beneath an area of dry land. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface as refracted seismic waves (110) or reflected seismic waves (114).

Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may be also boundaries between faults, fractures, or groups of fractures within a rock. The geological discontinuities (112) may delineate a hydrocarbon reservoir (104).

At the surface, refracted seismic waves (110) and reflected seismic waves (114) may be detected by seismic receivers (116). Radiated seismic waves (108) that propagate from the seismic source (106) directly to the seismic receivers (116), known as direct seismic waves (122), are also detected by the seismic receivers (116).

In some embodiments, a seismic source (106) may be positioned at a location denoted (xₛ, yₛ) where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, xᵣ, yᵣ, t). The t-axis delimits the time sample at which the seismic acquisition system (100) activated the seismic source (106) and acquired the seismic data by the seismic receivers (116).

Seismic processing may reduce five-dimensional seismic data produced by a seismic acquisition system (100) to three-dimensional (x,y,t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired over different time intervals, such as, for example, in cases where seismic surveys are repeated to obtain time-lapse data. Seismic data may also be pre-processed data, e.g., arranging data in a “common shot gather” (CSG) domain, i.e., sorting waveforms as acquired by different receivers and having a single source location. The noted seismic data is not intended as limiting, and any other suitable seismic data is intended to fall within the scope of the present disclosure.

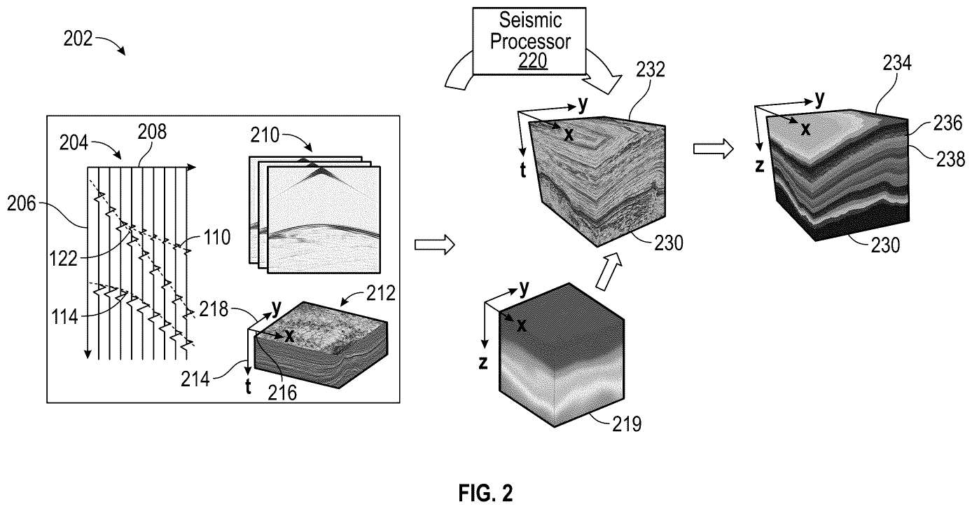

FIG. 2 shows examples of seismic data (202) produced by a seismic acquisition system (100) in accordance with one or more embodiments. An example of a CSG (204) illustrates the detection of direct seismic waves (122), refracted seismic waves (110), and reflected seismic waves (114) generated by a single activation of the seismic source (106) and recorded by a several colinear seismic receivers (116). Each seismic receiver (116) may record a time-series representing the amplitude of ground-motion at a sequence of discrete times. This time-series may be denoted or otherwise referred to as a “waveform”.

In the CSG (204) shown in FIG. 2 the vertical axis indicates the time (206) and the horizontal axis indicates the offset (208). In some embodiments, direct seismic waves (122), refracted seismic waves (110), and reflected seismic waves (114) may be located in the CSG (204) by their arrival times, i.e., the times instants they are first detected by the seismic receivers (116). The location of a particular type of wave in seismic data (202) acquired in time and space, such as in CSG (204), may be termed as an “arrival” or as an “event”.

The CSG (204) illustrates how the arrivals are detected at later times by the seismic receivers (116) that are farther from the seismic source (106). In some embodiments, arrivals of direct seismic waves (122) in the CSG (204) may be characterized by a straight line, while arrivals of reflected seismic waves (114) may present a hyperbolic shape, as seen in FIG. 2. Refracted seismic waves (110) may be characterized by arrivals in a form that approximates a straight line.

In one or more embodiments, seismic data (202) acquired by a seismic acquisition system (100) may be arranged in a plurality of CSGs (210) to create a 3D seismic dataset. Alternatively, the seismic data may be represented as a “seismic volume” (212) consisting of a plurality of time-space waveforms with a time axis (214), a first spatial dimension (216), and a second spatial dimension (218), where the first spatial dimension (216) and second spatial dimension (218) are orthogonal and span the Earth's surface above the subsurface region of interest (102).

Seismic data (202) may be processed by a seismic processor (220) to generate a seismic velocity model (219) of the subterranean region of interest (102). A seismic velocity model (219) is a representation of seismic velocity at a plurality of locations within a subterranean region of interest (102). Seismic velocity is the speed at which a seismic wave, that may be a pressure-wave or a shear-wave, travel through a medium. Pressures waves are often referred to as “primary-waves” or “P-waves”. Shear waves are often referred to “secondary waves” or “S-waves”. Seismic velocities in a seismic velocity model (219) may vary in vertical depth, in one or more horizontal directions, or both. Layers of rock may be created from different materials or created under varying conditions. Each layer of rock may have different physical properties from neighboring layers and these different physical properties may include seismic velocity.

In some embodiments, seismic data (202) is processed by a seismic processor (220) to generate a seismic image (230) of the subterranean region of interest (102). For example, a time-domain seismic image (232) may be generated using a process called seismic migration (also referred to as “migration” herein) using a seismic velocity model (219). In seismic migration, seismic events (e.g., reflections, refractions) recorded at the surface are relocated in either time or space to the location the event occurred in the subsurface. In some embodiments, migration may transform pre-processed shot gathers from a time-domain to a depth-domain seismic image (234). In a depth-domain seismic image (234), seismic events in a migrated shot gather may represent geological boundaries (236, 238) in the subsurface. Various types of migration algorithms may be used in seismic imaging. For example, one type of migration algorithm corresponds to reverse time migration.

A seismic image (230) of high resolution may be obtained if densely-recorded data is acquired by using closely-spaced shots and seismic receivers. For example, seismic waves with a bandwidth extending up to 100 Hz or more may resolve thin features. However, the accuracy of the seismic velocity model (219) may have an important impact on the quality of the seismic image (230). Determining an accurate seismic velocity model (219) may be a costly, time-consuming, and error-prone task. In some cases, the problem may be non-unique, i.e., a plurality of velocity models may fit the data. In other cases, data quality or inappropriate choices of inversion or modeling methods may produce inferior results. Some processing techniques focus on improving the seismic velocity model (219), for example, by correcting the location of boundaries in the seismic velocity model (219). Other processing techniques are applied directly to the seismic image (230) to improve its quality after its generation.

As illustrated in FIG. 2, processing of seismic data (202) may generate a seismic image (230) that may reveal the three-dimensional geometry of a subsurface region of interest (102). In particular, the geological boundaries (236, 238) may delineate a hydrocarbon reservoir (104). If a seismic image (230) indicates the potential presence of hydrocarbons in the subsurface region of interest (102), a drilling system may drill a wellbore (118) to confirm the presence of those hydrocarbons.

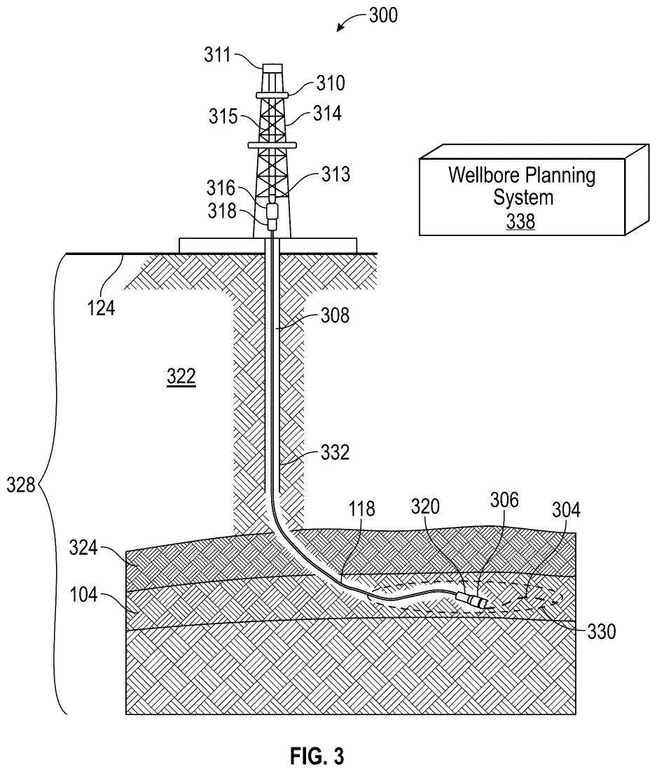

FIG. 3 shows a drilling system (300) in accordance with one or more embodiments. As shown in FIG. 3, a wellbore (118) following a wellbore trajectory (304) may be drilled by a drill bit (306) attached by a drillstring (308) to a drilling rig (310) located on the surface (124) of the earth. The drilling rig (310) may include framework, such as a derrick (314) to hold drilling machinery. A crown block (311) may be mounted at the top of the derrick (314), and a traveling block (313) may hang down from the crown block (311) by means of a cable (315) or drilling line. One end of the cable (315) may be connected to a drawworks (not shown), which is a reeling device that may be used to adjust the length of the cable (315) so that the traveling block (313) may move up or down the derrick (314).

A top drive (316) provides clockwise torque via the drive shaft (318) to the drillstring (308) in order to drill the wellbore (118). The drillstring (308) may comprise a plurality of sections of drillpipe attached at the uphole end to the drive shaft (318) and downhole to a bottomhole assembly (“BHA”) (320). The BHA (320) may be composed of a plurality of sections of heavier drillpipe and one or more measurement-while-drilling (“MWD”) tools configured to measure drilling parameters, such as torque, weight-on-bit, drilling direction, temperature, etc., and one or more logging tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124) using any suitable telemetry system known in the art. The BHA (320) and the drillstring (308) may include other drilling tools known in the art but not specifically shown.

The wellbore (118) may traverse a plurality of overburden (322) layers and one or more formations (324) to a hydrocarbon reservoir (104) within the subterranean region (328), and specifically to a drilling target (330) within the hydrocarbon reservoir (104). The wellbore trajectory (304) may be a curved or a straight trajectory. All or part of the wellbore trajectory (304) may be vertical, and some parts of the wellbore trajectory (304) may be deviated or have horizontal sections. One or more portions of the wellbore (118) may be cased with casing (332) in accordance with a wellbore plan.

To start drilling, or “spudding in” the well, the hoisting system lowers the drillstring (308) suspended from the derrick (314) towards the planned surface location of the wellbore (118). An engine, such as an electric motor, may be used to supply power to the top drive (316) to rotate the drillstring (308) through the drive shaft (318). The weight of the drillstring (308) combined with the rotational motion enables the drill bit (306) to bore the wellbore (118).

The drilling system (300) may be disposed at and communicate with other systems in the well environment, such as a seismic processor (220) and a wellbore planning system (338). The drilling system (300) may control at least a portion of a drilling operation by providing controls to various components of the drilling operation. In one or more embodiments, the drilling system (300) may receive well-measured data from one or more sensors and/or logging tools arranged to measure controllable parameters of the drilling operation. During operation of the drilling system (300), the well-measured data may include mud properties, flow rates, drill volume and penetration rates, rock physical properties, etc.

In some embodiments, the rock physical properties may be used by a seismic processor (220) to help determine a location of a hydrocarbon reservoir (104) (or other subterranean features). Knowledge of the existence and location of the hydrocarbon reservoir (104) and other subterranean features may be transferred from the seismic processor (220) to a wellbore planning system (338). The wellbore planning system (338) may use information regarding the hydrocarbon reservoir (104) location to plan a well, including a wellbore trajectory (304) from the surface (124) of the earth to penetrate the hydrocarbon reservoir (104). In addition, to the depth and geographic location of the hydrocarbon reservoir (104), the planned wellbore trajectory (304) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (304) may be transferred to the drilling system (300) described in FIG. 3. The drilling system (300) may drill the wellbore (118) along the planned wellbore trajectory (304) to access the drilling target (330) in the hydrocarbon reservoir (104).

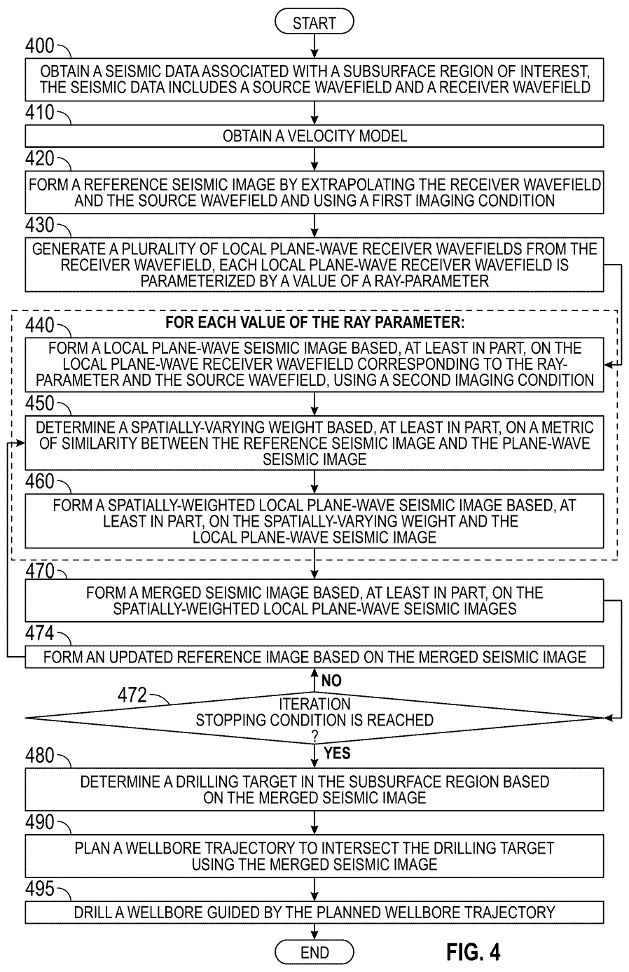

Turning to FIG. 4, FIG. 4 shows a flowchart in accordance with one or more embodiments. Specifically, FIG. 4 describes a general method to generate a merged seismic image from seismic images of corresponding to plane-wave components, including local plane-wave components, of seismic wavefields. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, seismic data (202) associated with a subsurface region of interest is obtained, in accordance with one or more embodiments. The seismic data (202) may be acquired using a seismic acquisition system (100) above a subsurface region of interest (102). The seismic data (202) may be processed to attenuate noise and may be organized in one or more spatial dimensions (216, 218) and a time axis (214) to form a plurality of time-space waveforms. In some embodiments, one or more CSGs (210) may be generated with the source position corresponding to the middle of the offset, as illustrated in FIG. 2.

The seismic data (202) includes a source wavefield and a receiver wavefield. The source wavefield may include one or more source functions at one or more source locations (xₛ, yₛ) used during activation of the seismic source (106). The receiver wavefield may include the plurality of waveforms acquired at the seismic receivers (116).

In Block 410, a velocity model regarding the subsurface region of interest is obtained, in accordance with one or more embodiments. The seismic velocity model (219) provides an estimate of at least one seismic wave propagation velocity at each location in the depth domain within the subterranean region of interest (102). Typically, a seismic velocity model (219) is specified by at least one seismic velocity for a particular wave type at a plurality of discrete grid points spanning the subsurface region of interest, but other specifications are possible. For example, the seismic velocity model (219) may be defined by a plurality of continuously varying mathematical functions.

An accurate velocity model may be useful for accurate simulations and forward modeling of the subsurface. A velocity model may be constructed by processing recorded seismic data (202) obtained using a seismic acquisition system (100). Processing seismic data (202) to obtain a velocity model may be considered an inverse problem, where the applied process must determine the subsurface velocity model that resulted in the recorded seismic data (202). The various processes and techniques used to process seismic data (202) to form a velocity model may generally be categorized as either a “data-domain approach”, such as full-waveform inversion (FWI), or an “image-domain approach”, such as migration velocity analysis. Machine learning models and deep learning frameworks may be also implemented to determine a velocity model from given seismic data (202).

In Block 420, a reference seismic image is formed by extrapolating the receiver wavefield and the source wavefield and using a first imaging condition, in accordance with one or more embodiments. Various types of algorithms may be used in the generation of a reference seismic image. For example, given a source wavefield and a receiver wavefield, a one-way equation may be used to extrapolate the two wavefields from the surface to all depths in the subsurface. The down-going one-way wave equation may be used to extrapolate the source wavefield, and the up-going one-way wave equation may be used to extrapolate the receiver wavefield. Furthermore, a phase shift plus interpolation (PSPI) method may be used to extrapolate the wavefields.

In other embodiments, the reference image may be generated with reverse time migration (RTM) using the two-way wave equation. In RTM, a source wavefield may be obtained by forward modelling the propagation of a synthetic source function using the velocity model. A receiver wavefield may be generated using the same velocity model by backward propagating in time the receiver wavefield. In other words, the receiver wavefield may be first reversed in time and the used as a source function applied at the corresponding seismic receivers (116) to simulate a radiated wavefield.

The reference seismic image may then be formed by applying a first imaging condition to the receiver wavefield and the source wavefield. In some embodiments, the first imaging condition may be represented by a cross-correlation between the source wavefield with the receiver wavefield under the basic assumption that the source wavefield represents the down-going wave-field and the receiver wave-field the up-going wave-field. Given an extrapolated source wavefield S(x, y, z, ω) and an extrapolated receiver wavefield R(x, y, z, ω), being both transformed to the frequency domain, the reference seismic image may be given by the following equation:

$$I ( x , y , z ) = {\sum }_{S} {\sum }_{ω} S ( x , y , z , ω ) R ( x , y , z , ω ) \qquad ( 1 )$$

where S denotes the one or more seismic sources and ω the temporal circular frequency. Other frequency-domain migration methods known in the art may be used to generate the reference seismic image, such as the split-step Fourier, the Fourier finite-differences, implicit ω-x finite-differences, phase shift, etc.

In Block 430, a plurality of local plane-wave receiver wavefields is determined from the extrapolated receiver wavefield, in accordance with one or more embodiments. The receiver wavefield may be transformed into a transformed receiver wavefield in a ray-parameter, p-domain. Each local plane-wave receiver wavefield R_{d}(x, y, z, ω; p) is parameterized by a value of the ray-parameter p.

The plurality of local plane-wave receiver wavefields may be generated by decomposing the extrapolated receiver wavefield R(x, y, z, ω) into local plane-wave components. According to one or more embodiments, the local plane-wave receiver wavefield may be generated by applying a windowed Radon transform to the extrapolated receiver wavefields R(x, y, z, ω) as follows

$${R}_{d} ( x , y , z , ω ; p ) = {\sum }_{{x}^{′} = - δ x}^{{x}^{′} = + δ x} R ( {x}^{′} , y , z , ω ) exp [ - i ω p ( x + {x}^{′} ) ] \qquad ( 2 )$$

where δx is the half window width and x′ represents the shift towards the center of the window. Even though in Equation (2) computations are performed with windows in the x-direction, Equation (2) may be adapted to use windows in other horizontal directions. The parameter p is the plane slope given by

$$p = \frac{sin {θ}_{r}}{v} \qquad ( 3 )$$

where θᵣ is the propagation angle of receiver wave paths, and v is the local interval velocity. Furthermore, in one or more embodiments, the plane slope may have two horizontal components associated with an azimuthal angle φ, as follows

$${p}_{x} = \frac{sin {θ}_{r} cos φ}{v} {p}_{y} = \frac{sin {θ}_{r} sin φ}{v} \qquad ( 3 )$$

and then the extrapolated receiver wavefield R(x, y, z, ω) may be decomposed into local plane-wave components R_{d}(x, y, z, ω; pₓ, p_{y}) with a 2D Radon Transform.

In other embodiments, the implementation of a recursive Radon transform may reduce the computational time spent to generate each local plane-wave receiver wavefield. A recursive Radon transform may be obtained by writing Equation (2) in terms of auxiliary variables as follows:

$${R}_{d} ( x , y , z , ω ; p ) = exp ( - i ω p x ) F ( x , y , z , ω ; p ) \qquad ( 4 )$$

$$F ( x , y , z , ω ; p ) = {\sum }_{{x}^{′} = x - δ x}^{x + δ x} C ( {x}^{′} y , z , ω ; p ) \qquad ( 5 )$$

$$C ( {x}^{′} , y , z , ω ; p ) = R ( {x}^{′} , y , z , ω ) exp [ - i ω {px}^{′} ] \qquad ( 6 )$$

where C and F are the auxiliary variables. Equations (4)-(6) are equivalent to Equation (2) and allow a recursive implementation to compute the Radon transform. Let xⱼ denote the center point of a j-th window containing 2δx+1 points. The evaluation of the Radon transform at the next, (j+1)-th window, may be evaluated using Equation (4):

$${R}_{d} ( {x}_{j + 1} , y , z , ω ; p ) = exp ( - i ω p {x}_{j + 1} ) F ( {x}_{j + 1} , y , z , ω ; p ) \qquad ( 7 )$$

Then, the variable F in Equation (5) may be obtained for the (j+1)-th window using the sum for the j-th window as follows:

$$F ( {x}_{j + 1} , y , z , ω ; p ) = F ( {x}_{j} , y , z , ω ; p ) - C ( {x}_{j - δ x} , y , z , ω ; p ) + C ( {x}_{j + δ x + 1} , y , z , ω ; p ) \qquad ( 8 )$$

Thus, the evaluation of F for the (j+1)-th window may performed with only two additional operations, the subtraction of C at the point x_{j-δx}, and the addition of the C at the point x_{j-δx+1}. Furthermore, the phase shifting factor exp (−iωpxⱼ₊₁) may be multiplied in Equation (7) after performing the subtracting and addition operations. The resulting recursive algorithm may reduce the computational complexity of evaluating the Radon Transform from O(M×N²) to O(M×N), by avoiding the calculation of shared points between adjacent windows.

In Block 440, a local plane-wave seismic image is formed for each value of the ray parameter, in accordance with one or more embodiments. The local plane-wave seismic image is formed applying a second imaging condition to the local plane-wave receiver wavefield and the source wavefield. The local plane-wave seismic image Iₚ may be computed with the following equation:

$${I}_{p} ( x , y , z , p ) = {\sum }_{S} {\sum }_{ω} S ( x , y , z , ω ) {R}_{d} ( x , y , z , ω ; p ) \qquad ( 9 )$$

One desirable result of generating local plane-wave seismic images may be that they allow the identification of the seismic images with higher errors or inaccuracies. When the accuracy of the velocity model is low, the impact of inaccuracies on the local plain-wave seismic images may differ according to the wave paths. By separating the local plane-wave seismic images by their quality, processing techniques may be implemented to improve the accuracy of the seismic image (230).

The proposed method is illustrated using a synthetic example as is common in the art and is advantageous at least because the solutions are known a priori. The example starts with a numerical representation of a simplified portion of the earth (the “model”). Then synthetic data is generated from the numerical solution of the differential equation describing the physics of seismic wave propagation. Embodiments of the disclosed invention are applied to the synthetic data and the results are compared with the model to assess the performance of the disclosed embodiments.

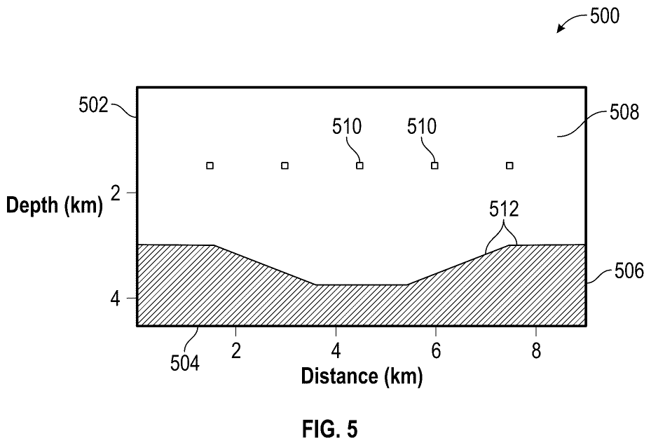

FIG. 5 shows an example of a P-wave velocity model (500) used to illustrate the generation of local plane-wave seismic images, according to some embodiments. The vertical axis indicates the depth-dimension (502), and the horizontal axis indicates one horizontal dimension (504). At the lower portion (506) of the model the P-wave velocity has a value of 3.5 km/s, and at the upper portion (508), a value of 2.5 km/s. The model is composed of five scatterers (510) and five reflectors (512). At the scatterers the P-wave velocity also has a value of 3.5 km/s.

With the P-wave velocity model (500) of FIG. 5, 200 simulations are performed. The source function includes a Ricker wavelet with a central frequency of 16 Hz. The simulated wavefield is registered at 600 seismic receivers that covered the entire surface of the model, with a receiver spacing of 15 m. The total recording time is 5 s, with a time step of 2 milliseconds (ms). The simulated wavefield at the receivers is decomposed into five local plane-wave receiver wavefields.

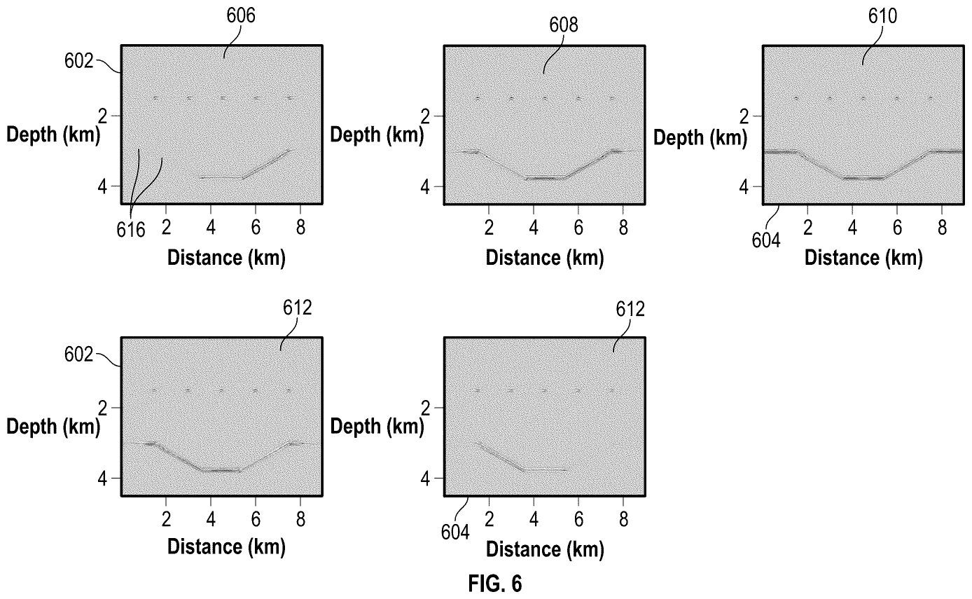

Using the simulated wavefields and a constant velocity model of 2.5 km/s, the local plane-wave seismic images shown in FIG. 6 are generated. The vertical axis indicates the depth-dimension (602), and the horizontal axis indicates the one horizontal dimension (604). Local plane-wave seismic images (606), (608), (610), (612), and (614) correspond respectively to plane slope or ray parameter values of −0.00032, −0.00016, 0, 0.00016, and 0.00032. The example of FIG. 6 illustrates that good results may be obtained in the different ray directions, and thus in the different local plane-wave seismic images, when the velocity model used in extrapolating the wavefields is accurate.

FIG. 6 illustrates the different illuminations to the reflectors (512) in the five plane-wave seismic images (606-614). It can be seen that some reflectors are not accurately imaged in the local plane-wave seismic image (606), such as reflectors (616). This is because the reflection angle related to reflectors (616) is not included in the local plane-wave seismic image (606). However, in all five plane-wave seismic images (606-614) the five reflectors (512) appear in the correct position, a result that is not surprising since the five local plane-wave seismic images (606-614) were generated using the correct P-wave velocity model (500). On the other hand, in the case of the scatterers (510), it can be observed that they are well imaged in the five local plane-wave seismic images (606-614). The reason being that scatterers (510) radiate scattered energy in a large range of directions, and thus each local plane-wave seismic image includes some of the scattered energy.

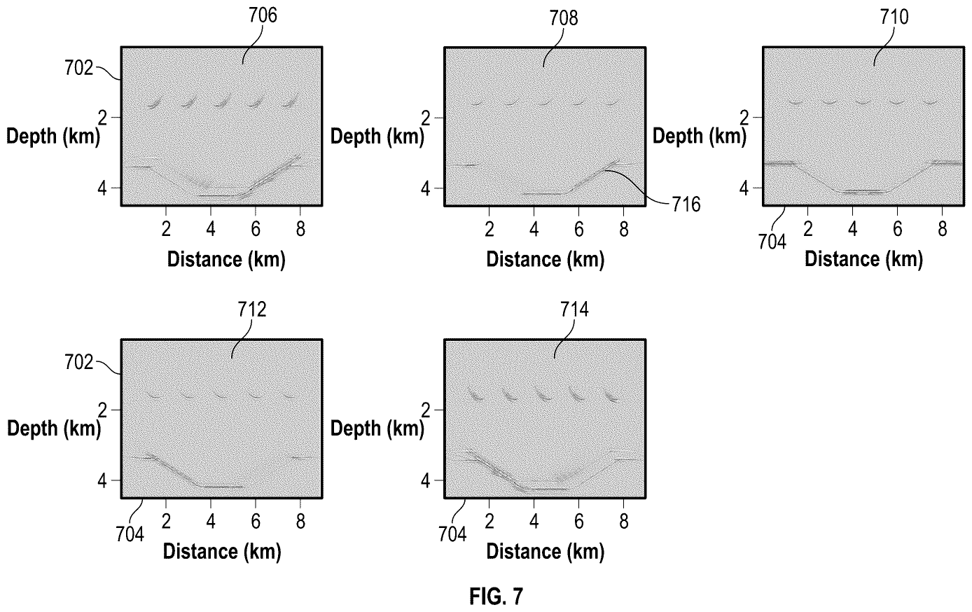

Turning to FIG. 7, FIG. 7 shows local plane-wave seismic images generated using the same simulated wavefields used for the results of FIG. 6, but now migration is performed using a slower velocity model, a constant velocity of 2.2 km/s. The vertical axis indicates the depth-dimension (702), and the horizontal axis indicates the one horizontal dimension (704). Local plane-wave seismic images (706), (708), (710), (712), and (714) correspond respectively to plane slope values of −0.0003, −0.00015, 0, 0.00015, and 0.0003.

FIG. 7 illustrates that in local plane-wave seismic images (706-714) most reflectors (512) and scatterers (510) appear blurred and unfocused. These inaccurate results are consequence of performing extrapolation of the wavefields with the wrong velocity model. One exception may be, for example, reflector (716) in local plane-wave seismic image (708) that appears coherent and focused. FIG. 7 illustrate how the local plane-wave seismic images (706-714) are affected differently by the inaccurate velocity model according to their respective slope value.

Returning to FIG. 4, in block 450, a spatially-varying weight is determined based on a metric of similarity between the reference seismic image and the plane-wave seismic image, according to one or more embodiments. The spatially-varying weight may be used to quantitively discriminate between the local plane-wave seismic images with high and those with low accuracy (or quality). As illustrated in FIG. 7, the local plane-wave seismic images represent seismic images associated with different wave paths, and thus they may be distorted differently by an inaccurate velocity model. Taking the reference seismic image as reference, a metric of similarity applied to each local plane-wave seismic image may assist in selecting the images having a desired level of accuracy.

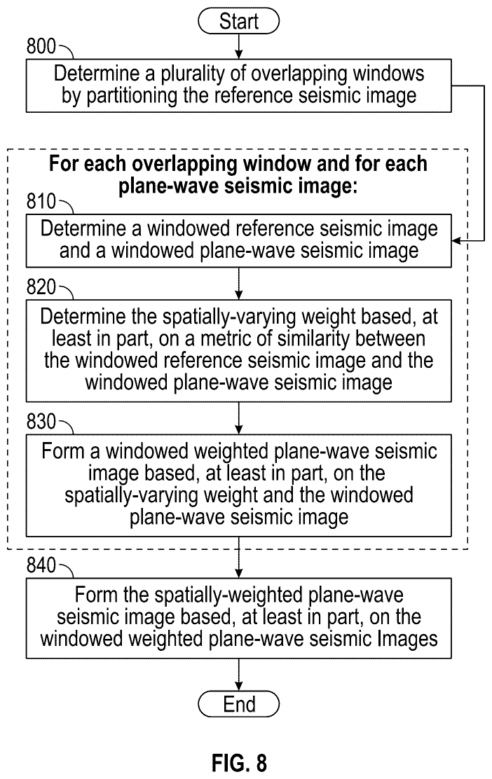

In some embodiments, the metric of similarity is applied to sub-images or windows of the reference seismic image. The reference seismic image may be partitioned into a plurality of overlapping windows as shown in Block 800 of FIG. 8. The window may extend in the vertical dimension and one or more horizontal dimension. For example, a window extending in the vertical dimension and in the x-horizontal dimension may be denoted by (wₓ, w_{z}). The size of the overlapping windows may be adapted to the size of the model under consideration. Non-limiting examples of the length of a window in the horizontal direction may be 500 m, 1 km, and 2 km. The use of overlapping windows may reduce artificial discontinuities that may appear at the windows boundaries from processing. The length of overlapping may be, for example, between 20% and 40% of the window's length.

Further, each local plane-wave seismic image may be partitioned using the overlapping windows in the same manner as the reference seismic image. Therefore, each overlapping window (wₓ, w_{z}) may determine a windowed reference seismic image I(x(wₓ, w_{z}), y, z(wₓ, w_{z}) and a windowed local plane-wave seismic image Iₚ(x(wₓ, w_{z}), y, z(wₓ, w_{z}), p), as shown in Block 810. The expressions x(wₓ, w_{z}) and z(wₓ, w_{z}) denote respectively the horizontal and vertical ranges of the window (wₓ, w_{z}).

In block 820, a windowed weight may be determined based on the metric of similarity applied to the windowed reference seismic image and the windowed local plane-wave seismic image. According to some embodiments, the spatially-varying weight W(wₓ, y, w_{z}, p) may be calculated with the expression:

$$W ( {w}_{x} , y , {w}_{z} , p ) = {[ {I}_{p} ( x ( {w}_{x} , {w}_{z} ) , y , z ( {w}_{x} , {w}_{z} ) , p ) \cdot I ( x ( {w}_{x} , {w}_{z} ) , y , z ( {w}_{x} , {w}_{z} ) ) ]}^{2} \qquad ( 10 )$$

where the operator · denotes the inner product (also known as dot product) of its arguments. A person of ordinary skill in the art will appreciate that the spatially-varying weight W(wₓ, y, w_{z}, p) may be calculated on any other desired horizontal direction different than the x-direction. Since in the art of image processing the inner product is related to correlation of images, the spatially-varying weight W(wₓ, y, w_{z}, p) given in Equation (10) may be considered a measure of the similarity between the windowed reference seismic image and the windowed local plane-wave seismic image. Furthermore, a person of ordinary skill in the art could recognize that the spatially-varying weight W(wₓ, y, w_{z}, p) may be based on other measures of similarity, for example, norms of the difference between subsections, the Jaccard similarity, the Pearson correlation, the Capon beamforming, etc.

Returning to FIG. 4, in Block 460, a spatially-weighted local plane-wave seismic image is formed based on a product of the spatially-varying weight and the local plane-wave seismic image, according to one or more embodiments. The product of the spatially-varying weight and the local plane-wave seismic image may attenuate the most distorted parts of each local plane-wave seismic image, while retaining the parts of the local plane-wave seismic image having a desired level of quality. In some embodiments, a windowed weighted local plane-wave seismic image may be obtained by performing the product of the spatially-varying weight W(wₓ, y, w_{z}, p) and the windowed local plane-wave seismic image Iₚ(x(wₓ, w_{z}), y, z(wₓ, w_{z}), p), as shown in Block 830.

The spatially-weighted local plane-wave seismic image I_{W}(x, y, z, p) may then be obtained by merging the windowed weighted local plane-wave seismic images, as shown in Block 840 in FIG. 8. The merging may be expressed, for example, by the following equation:

$${I}_{W} ( x , y , z , p ) = {\sum }_{{w}_{x}} {\sum }_{{w}_{z}} W ( {w}_{x} , y , {w}_{z} , p ) {I}_{p} ( x ( {w}_{x} , {w}_{z} ) , y , z ( {w}_{x} , {w}_{z} ) , p ) \qquad ( 7 )$$

In this merging step, the quality of the spatially-weighted local plane-wave seismic image I_{W}(x, y, z, p) may be improved relative to the quality of Iₚ(x, y, z, p), since the windowed local plane-wave seismic images of low-accuracy have been attenuated.

In Block 470, a merged seismic image is formed based on the spatially-weighted local plane-wave seismic images, according to one or more embodiments. The final, merged seismic image may be obtained by merging, or stacking, the spatially-weighted local plane-wave seismic images:

$${I}_{f} ( x , y , z ) = {\sum }_{p} {I}_{W} ( x , y , z , p ) \qquad ( 8 )$$

The quality of the merged seismic image obtained with Equation (8) may be increased because it is formed by merging the least-distorted, high-quality events present in the different local plane-wave seismic images.

In some embodiments, the quality of the merged seismic image may be further improved in several iterations, until a desired level of image quality is obtained. Specifically, after a first merged seismic image is generated, it may replace the reference seismic image used in the metric of similarity, to form an updated reference image as shown in Block 474. Then steps described in Blocks 450-470 of FIG. 4 regarding forming spatially-weighted local plane-wave seismic images and a merged seismic image are repeated. Steps described in Blocks 400-440 may not be repeated in the iterative process as they do not depend on the reference seismic image. By consecutively updating the reference seismic image with the merged seismic images of higher quality, the iterative process may quickly converge to a predetermined level of image quality, without a high increase in computational cost, until a stopping criterion is reached, as shown in Block 472.

In some embodiments, the predetermined level of image quality, or the stopping criterion, may be given in the form of a comparison criterion. Measurements for the comparison criterion may expressed in terms of the L2 norm of images, also known as the Euclidean norm. An example of a comparison criterion is given by the following expression:

$${‖ Δ {I}_{f} ( x , y , z ) ‖}^{2} < c \cdot {‖ {I}_{u f} ( x , y , z ) ‖}^{2} \qquad ( 9 )$$

where ∥·∥ denotes the L2 norm of its argument, and c is a constant that represents a predetermined threshold value. I_{uf}(x, y, z) denotes the updated merged seismic image and ΔI_{f}(x, y, z) is the difference between the updated merged seismic image and the reference seismic image. The predetermined threshold value may have values from 0.001 to 0.01. Expression (9) basically states that a desired level of image quality may be obtained when a measure (the L2 norm in this example) of ΔI_{f}(x, y, z) is small enough relative to a similar measure of the updated merged seismic image I_{uf}(x, y, z).

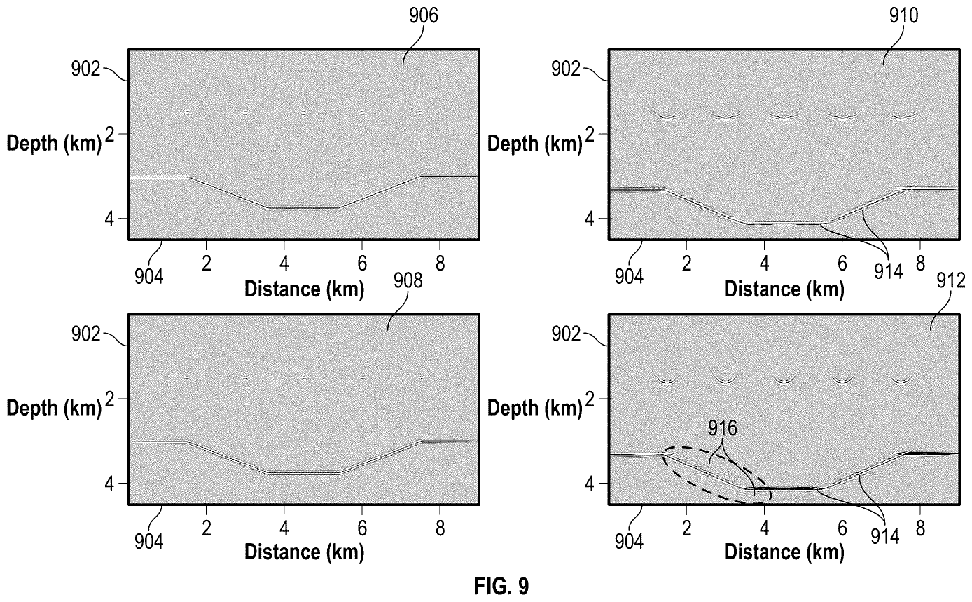

FIG. 9 illustrates examples of reference and merged seismic images generated from simulations based on the velocity model of FIG. 5, according to one or more embodiments. In all seismic images of FIG. 9 the vertical axis indicates the depth-dimension (902), and the horizontal axis indicates one horizontal dimension (904). The merged seismic image (906) and the reference seismic image (908) are generated with the correct velocity model (a constant velocity model of 2.5 km/s). On the other hand, the merged seismic image (910) and the reference seismic image (912) are generated with the slower velocity model. Furthermore, the merged seismic image (906) is generated by merging the five local plane-wave seismic images (606-614) after applying spatially-varying weights to them. Similarly, the merged seismic image (910) is generated by merging the five local plane-wave seismic images (706-714) after applying spatially-varying weights to them.

As seen in FIG. 9, the merged seismic image (906) generated with the proposed method and the reference seismic image (908) provide results of similar quality. This is because the correct velocity model was used in their generation. On the other hand, when using the inaccurate velocity model, the quality of the merged seismic image (910) may be better than the quality of the reference seismic image (912). For example, in reflectors (914) in the merged seismic image (910) are more coherent, focused and surrounded by less artifacts (916).

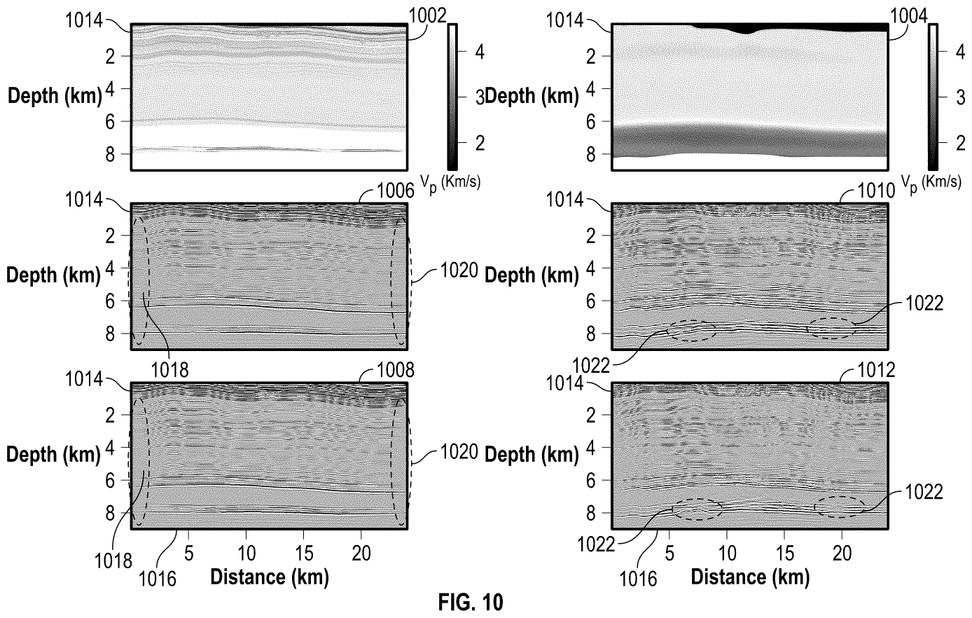

Another example that showcases the capabilities of the proposed method is shown in FIG. 10. FIG. 10 shows a refined velocity model (1002) that is used to perform numerical simulation of wave propagation. A less accurate velocity model (1004) is also shown in FIG. 10, which is generated to test the proposed method. FIG. 10 illustrates a merged seismic image (1006) and a reference seismic image (1008) generated with the refined velocity model (1002). The case of a merged seismic image (1010) and a reference seismic image (1012) generated with the less accurate velocity model (1004) is also illustrated in FIG. 10. In all velocity models and seismic images of FIG. 10 the vertical axis indicates the depth-dimension (1014), and the horizontal axis indicates one horizontal dimension (1016).

Numerical simulations are performed with the refined velocity model (1002) discretized on a spatial grid with a spacing of 15 m in each spatial dimension. In addition, the source function is modeled with a Ricker wavelet with a central frequency of 16 Hz. A number of 534 numerical simulations are performed using the one-way equation born modeling. The simulated dataset includes waveforms acquired at 1600 seismic receivers evenly distributed at the surface with a spacing of 15 m. On the other hand, the less accurate velocity model (1004) is generated by smoothing the refined velocity model (1002) with a Gaussian window.

The merged seismic image (1006) is generated by decomposing the receiver wavefields using the refined velocity model (1002) and forming 13 local plane-wave seismic images with slope values evenly distributed in the interval [−0.000825, 0.000825]. FIG. 10 shows that also in this example the merged seismic image (1006) can achieve the same quality as the reference seismic image (1008), if using the refined velocity model (1002). Furthermore, at the left and right boundaries (1018, 1020) the merged seismic image (1006) may achieve a resolution that is even better than the resolution of the reference seismic image (1008).

The merged seismic image (1010) is generated by decomposing the receiver wavefields using the less accurate velocity model (1002) and forming 13 local plane-wave components using the same slope values used to generate the merged seismic image (1006). When compared with the reference seismic image (1012), the merged seismic image (1010) shows better resolution with more coherent and focused events, such as those indicated in the areas (1022).

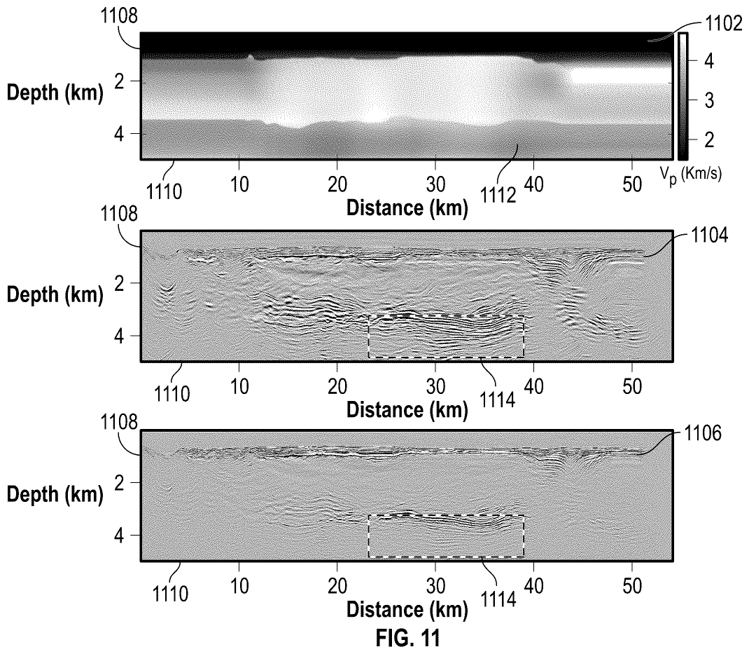

Turning to FIG. 11, FIG. 11 illustrates an example of generating a merged seismic image from marine seismic data, according to some embodiments. With a total recording time of 6 s, the marine seismic data was acquired at 2546 seismic receivers with a maximum offset of 9 km. FIG. 11 shows a P-wave velocity model (1102), a merged seismic image (1104), and a reference seismic image (1106), all generated using the marine seismic data. The vertical axis indicates the depth-dimension (1108), and the horizontal axis indicates one horizontal dimension (1110). A thick salt body (1112) is located in the lower section of the P-wave velocity model (1102).

The receiver wavefield is decomposed using the P-wave velocity model (1102) and 41 local plane-wave seismic images are formed with slope values evenly distributed in the interval [−5.84E−4, 5.84E−4] to generate the merged seismic image (1104). Once again, this example shows that the merged seismic image (1104) is in general more coherent and has better resolution than the reference seismic image (1106). In particular, the salt body (1112) is imaged with more clarity and more details, as shown in the dashed box (1114).

Returning to FIG. 4, in Block 480, a drilling target in the subsurface region may be determined based on the merged seismic image, in accordance with one or more embodiments. A drilling target (330) in a wellbore (118) may be based on, for example, an expected presence of gas or another hydrocarbon. Locations in a seismic image (230) may indicate an elevated probability of the presence of a hydrocarbon and may be targeted by well designers. On the other hand, locations in a seismic image (230) indicating a low probability of the presence of a hydrocarbon may be avoided by well designers.

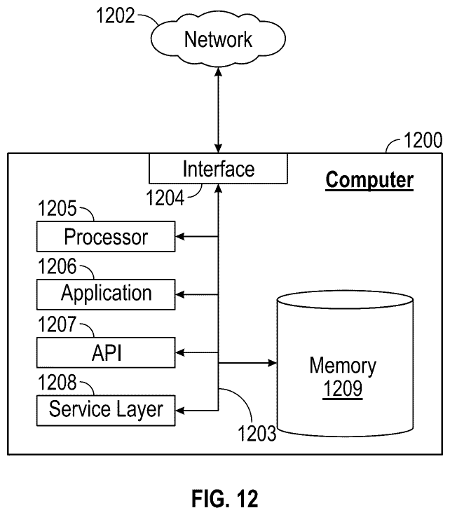

In Block 490, a wellbore trajectory to intersect the drilling target is planned using the seismic image, in accordance with one or more embodiments. Knowledge of the location of the drilling target (330) and the seismic image (230) may be transferred to a wellbore planning system (338). Instructions associated with the wellbore planning system (338) may be stored, for example, in the memory (1209) within the computer system (1200) described in FIG. 12 below. The wellbore planning system (338) may use the knowledge of the location of the drilling target (330) and of the seismic image (230) to plan a wellbore trajectory (304) within the subterranean region of interest (102).

In Block 495, a wellbore is drilled guided by the planned wellbore trajectory, in accordance with one or more embodiments. The wellbore planning system (338) may transfer the planned wellbore trajectory (304) to the drilling system (300) described in FIG. 3. The drilling system (300) may drill the wellbore (118) along the planned wellbore trajectory (304) to access and produce the hydrocarbon reservoir (104) to the surface (124).

In some embodiments the wellbore planning system (338) and the seismic processor (220) may each be implemented within the context of a computer system. FIG. 12 is a block diagram of a computer system (1200) used to provide computational functionalities associated with described algorithms, methods, functions, processes, flows, and procedures as described in the instant disclosure, according to an implementation. The illustrated computer (1200) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1200) may include a computer that includes an input device, such as a keypad, keyboard, touch screen, or other device that can accept user information, and an output device that conveys information associated with the operation of the computer (1200), including digital data, visual, or audio information (or a combination of information), or a GUI.

The computer (1200) can serve in a role as a client, network component, a server, a database or other persistency, or any other component (or a combination of roles) of a computer system for performing the subject matter described in the instant disclosure. The illustrated computer (1200) is communicably coupled with a network (1202). In some implementations, one or more components of the computer (1200) may be configured to operate within environments, including cloud-computing-based, local, global, or other environment (or a combination of environments).

At a high level, the computer (1200) is an electronic computing device operable to receive, transmit, process, store, or manage data and information associated with the described subject matter. According to some implementations, the computer (1200) may also include or be communicably coupled with an application server, e-mail server, web server, caching server, streaming data server, business intelligence (BI) server, or other server (or a combination of servers).

The computer (1200) can receive requests over network (1202) from a client application (for example, executing on another computer (1200)) and responding to the received requests by processing the said requests in an appropriate software application. In addition, requests may also be sent to the computer (1200) from internal users (for example, from a command console or by other appropriate access method), external or third-parties, other automated applications, as well as any other appropriate entities, individuals, systems, or computers.

Each of the components of the computer (1200) can communicate using a system bus (1203). In some implementations, any or all of the components of the computer (1200), both hardware or software (or a combination of hardware and software), may interface with each other or the interface (1204) (or a combination of both) over the system bus (1203) using an application programming interface (API) (1207) or a service layer (1208) (or a combination of the API (1207) and service layer (1208). The API (1207) may include specifications for routines, data structures, and object classes. The API (1207) may be either computer-language independent or dependent and refer to a complete interface, a single function, or even a set of APIs. The service layer (1208) provides software services to the computer (1200) or other components (whether or not illustrated) that are communicably coupled to the computer (1200). The functionality of the computer (1200) may be accessible for all service consumers using this service layer (1208). Software services, such as those provided by the service layer (1208), provide reusable, defined business functionalities through a defined interface. For example, the interface may be software written in JAVA, C++, or other suitable language providing data in extensible markup language (XML) format or other suitable format. While illustrated as an integrated component of the computer (1200), alternative implementations may illustrate the API (1207) or the service layer (1208) as stand-alone components in relation to other components of the computer (1200) or other components (whether or not illustrated) that are communicably coupled to the computer (1200). Moreover, any or all parts of the API (1207) or the service layer (1208) may be implemented as child or sub-modules of another software module, enterprise application, or hardware module without departing from the scope of this disclosure.

The computer (1200) includes an interface (1204). Although illustrated as a single interface (1204) in FIG. 12, two or more interfaces (1204) may be used according to particular needs, desires, or particular implementations of the computer (1200). The interface (1204) is used by the computer (1200) for communicating with other systems in a distributed environment that are connected to the network (1202). Generally, the interface (1204) includes logic encoded in software or hardware (or a combination of software and hardware) and operable to communicate with the network (1202). More specifically, the interface (1204) may include software supporting one or more communication protocols associated with communications such that the network (1202) or interface's hardware is operable to communicate physical signals within and outside of the illustrated computer (1200).

The computer (1200) includes at least one computer processor (1205). Although illustrated as a single computer processor (1205) in FIG. 12, two or more processors may be used according to particular needs, desires, or particular implementations of the computer (1200). Generally, the computer processor (1205) executes instructions and manipulates data to perform the operations of the computer (1200) and any algorithms, methods, functions, processes, flows, and procedures as described in the instant disclosure.

The computer (1200) also includes a memory (1209) that holds data for the computer (1200) or other components (or a combination of both) that may be connected to the network (1202). For example, memory (1209) may be a database storing data consistent with this disclosure. Although illustrated as a single memory (1209) in FIG. 12, two or more memories may be used according to particular needs, desires, or particular implementations of the computer (1200) and the described functionality. While memory (1209) is illustrated as an integral component of the computer (1200), in alternative implementations, memory (1209) may be external to the computer (1200).

The application (1206) is an algorithmic software engine providing functionality according to particular needs, desires, or particular implementations of the computer (1200), particularly with respect to functionality described in this disclosure. For example, application (1206) can serve as one or more components, modules, applications, etc. Further, although illustrated as a single application (1206), the application (1206) may be implemented as multiple applications (1206) on the computer (1200). In addition, although illustrated as integral to the computer (1200), in alternative implementations, the application (1206) may be external to the computer (1200).

There may be any number of computers (1200) associated with, or external to, a computer system containing computer (1200), each computer (1200) communicating over network (1202). Further, the term “client,” “user,” and other appropriate terminology may be used interchangeably as appropriate without departing from the scope of this disclosure. Moreover, this disclosure contemplates that many users may use one computer (1200), or that one user may use multiple computers (1200).

In some embodiments, the computer (1200) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining seismic data regarding a subsurface region of interest, wherein the seismic data comprises a source wavefield and a receiver wavefield;
obtaining a velocity model regarding the subsurface region of interest;
forming a reference seismic image based, at least in part, on the seismic data and the velocity model, by extrapolating the receiver wavefield and the source wavefield and using a first imaging condition;
determining a plurality of local plane-wave receiver wavefields from the receiver wavefield, wherein each local plane-wave receiver wavefield is parameterized by a value of a ray-parameter;
for each value of the ray-parameter:
forming a local plane-wave seismic image based, at least in part, on the local plane-wave receiver wavefield corresponding to the ray-parameter and the source wavefield using a second imaging condition,
determining a spatially-varying weight based, at least in part, on a metric of similarity between the reference seismic image and the local plane-wave seismic image, and
forming a spatially-weighted local plane-wave seismic image based, at least in part, on the spatially-varying weight and the local plane-wave seismic image;
forming a merged seismic image based, at least in part, on the spatially-weighted local plane-wave seismic images; and
determining, a drilling target in the subsurface region based on the merged seismic image.

2. The method of claim 1, further comprising:
planning, using a wellbore planning system, a planned wellbore trajectory to intersect the drilling target in the subsurface region using the merged seismic image; and
drilling, using a drilling system, a wellbore guided by the planned wellbore trajectory.

3. The method of claim 1, further comprising, iteratively, or recursively, until a stopping condition is reached:
forming an updated reference image based on the merged seismic image;
for each value of the ray-parameter:
determining the spatially-varying weight based, at least in part, on a metric of similarity between the updated reference seismic image and the local plane-wave seismic image, and
forming the spatially-weighted local plane-wave seismic image based, at least in part, on the spatially-varying weight and the local plane-wave seismic image;
updating the merged seismic image based, at least in part, on the spatially-weighted local plane-wave seismic images.

4. The method of claim 1, wherein extrapolating the receiver wavefield and the source wavefield comprises using a one-way wave equation.

5. The method of claim 1, wherein extrapolating the receiver wavefield and the source wavefield comprises using phase shift plus interpolation.

6. The method of claim 1, wherein determining a plurality of local plane-wave receiver wavefields comprises performing a windowed Radon Transform.

7. The method of claim 1, wherein forming the spatially-weighted local plane-wave seismic image comprises:
determining a plurality of overlapping windows by partitioning the reference seismic image;
for each overlapping window and for each local plane-wave seismic image:
determining a windowed reference seismic image and a windowed local plane-wave seismic image,
determining the spatially-varying weight based, at least in part, on a metric of similarity between the windowed reference seismic image and the windowed local plane-wave seismic image, and
forming a windowed weighted local plane-wave seismic image based, at least in part, on the spatially-varying weight and the windowed local plane-wave seismic image; and
forming the spatially-weighted local plane-wave seismic image based, at least in part, on a combination of the windowed weighted local plane-wave seismic images.

8. The method of claim 1, wherein the metric of similarity comprises performing an inner product.

9. A non-transitory computer-readable medium comprising computer-executable instructions stored thereon that, when executed by a processor, cause the processor to perform steps comprising:
obtaining seismic data regarding a subsurface region of interest, wherein the seismic data comprises a source wavefield and a receiver wavefield;
obtaining a velocity model regarding the subsurface region of interest;
forming a reference seismic image based, at least in part, on the seismic data and the velocity model, by extrapolating the receiver wavefield and the source wavefield and using a first imaging condition;
determining a plurality of local plane-wave receiver wavefields from the receiver wavefield, wherein each local plane-wave receiver wavefield is parameterized by a value of a ray-parameter;
for each value of the ray-parameter:
forming a local plane-wave seismic image based, at least in part, on the local plane-wave receiver wavefield corresponding to the ray-parameter and the source wavefield using a second imaging condition,
determining a spatially-varying weight based, at least in part, on a metric of similarity between the reference seismic image and the local plane-wave seismic image, and
forming a spatially-weighted local plane-wave seismic image based, at least in part, on the spatially-varying weight and the local plane-wave seismic image;
forming a merged seismic image based, at least in part, on the spatially-weighted local plane-wave seismic images; and
determining, a drilling target in the subsurface region based on the merged seismic image.

10. The non-transitory computer-readable medium of claim 9, wherein the steps further comprise, iteratively, or recursively, until a stopping condition is reached:
forming an updated reference image based on the merged seismic image;
for each value of the ray-parameter:
determining the spatially-varying weight based, at least in part, on a metric of similarity between the updated reference seismic image and the local plane-wave seismic image, and
forming the spatially-weighted local plane-wave seismic image based, at least in part, on the spatially-varying weight and the local plane-wave seismic image;
forming the merged seismic image based, at least in part, on the spatially-weighted local plane-wave seismic images.

11. The non-transitory computer-readable medium of claim 9, wherein the steps further comprise:
extrapolating the receiver wavefield and the source wavefield by using a one-way wave equation.

12. The non-transitory computer-readable medium of claim 9, wherein the steps further comprise:
extrapolating the receiver wavefield and the source wavefield by using phase shift plus interpolation.

13. The non-transitory computer-readable medium of claim 9, wherein the steps further comprise:
determining a plurality of local plane-wave receiver wavefields by performing a windowed Radon Transform.

14. The non-transitory computer-readable medium of claim 9, wherein the steps further comprise:
determining a plurality of overlapping windows by partitioning the reference seismic image;
for each overlapping window and for each local plane-wave seismic image:
determining a windowed reference seismic image and a windowed local plane-wave seismic image,
determining the spatially-varying weight based, at least in part, on a metric of similarity between the windowed reference seismic image and the windowed local plane-wave seismic image, and
forming a windowed weighted local plane-wave seismic image based, at least in part, on the spatially-varying weight and the windowed local plane-wave seismic image; and
forming the spatially-weighted local plane-wave seismic image based, at least in part, on a combination of the windowed weighted local plane-wave seismic images.

15. A system, comprising:
a seismic acquisition system configured to record seismic data regarding a subsurface region of interest; and
a seismic processor configured to receive the seismic data and to:
obtain seismic data regarding a subsurface region of interest, wherein the seismic data comprises a source wavefield and a receiver wavefield,
obtain a velocity model regarding the subsurface region of interest,
form a reference seismic image based, at least in part, on the seismic data and the velocity model, by extrapolating the receiver wavefield and the source wavefield and using a first imaging condition,
determine a plurality of local plane-wave receiver wavefields from the receiver wavefield, wherein each local plane-wave receiver wavefield is parameterized by a value of a ray-parameter,
for each value of the ray-parameter:
form a local plane-wave seismic image based, at least in part, on the local plane-wave receiver wavefield corresponding to the ray-parameter and the source wavefield using a second imaging condition;
determine a spatially-varying weight based, at least in part, on a metric of similarity between the reference seismic image and the local plane-wave seismic image; and
form a spatially-weighted local plane-wave seismic image based, at least in part, on the spatially-varying weight and the local plane-wave seismic image,
form a merged seismic image based, at least in part, on the spatially-weighted local plane-wave seismic images, and
determine, a drilling target in the subsurface region based on the merged seismic image.

16. The system of claim 15, further comprising:
a wellbore planning system to plan configured to plan a planned wellbore trajectory to intersect the drilling target in the subsurface region using the merged seismic image; and
a drilling system to drill a wellbore guided by the planned wellbore trajectory.

17. The system of claim 15, wherein the seismic processor is further configured to:
iteratively, or recursively, until a stopping condition is reached:
form an updated reference image based on the merged seismic image;
for each value of the ray-parameter:
determine the spatially-varying weight based, at least in part, on a metric of similarity between the updated reference seismic image and the local plane-wave seismic image, and
form the spatially-weighted local plane-wave seismic image based, at least in part, on the spatially-varying weight and the local plane-wave seismic image;
form the merged seismic image based, at least in part, on the spatially-weighted local plane-wave seismic images.

18. The system of claim 15, wherein the seismic processor is further configured to generate the receiver wavefield and the source wavefield by using phase shift plus interpolation.

19. The system of claim 15, wherein the seismic processor is further configured to determine a plurality of local plane-wave receiver wavefields by performing a recursive Radon Transform.

20. The system of claim 15, wherein the seismic processor is further configured to:
determine a plurality of overlapping windows by partitioning the reference seismic image;
for each overlapping window and for each local plane-wave seismic image:
determine a windowed reference seismic image and a windowed local plane-wave seismic image,
determine the spatially-varying weight based, at least in part, on a metric of similarity between the windowed reference seismic image and the windowed local plane-wave seismic image, and
form a windowed weighted local plane-wave seismic image based, at least in part, on the spatially-varying weight and the windowed local plane-wave seismic image; and
form the spatially-weighted local plane-wave seismic image based, at least in part, on a combination of the windowed weighted local plane-wave seismic images.
